(19) United States
(12) Patent Application Publication
(10) Pub. No.: US 2020/0030891 A1
(43) Pub. Date: Jan. 30, 2020

(54) Pocket Hole Jig Stop Systems

(71) Applicant: Mark A. Duginske, Merrill, WI (US)

(72) Inventor: Mark A. Duginske, Merrill, WI (US)

(21) Appl. No.: 16/521,418

(22) Filed: Jul. 24, 2019

Related U.S. Application Data
(60) Provisional application No. 62/702,705, filed on Jul. 24, 2018.

(51) Int. Cl. B23B 47/28

(52) U.S. Cl. CPC B23B 47/287; B23B 2260/004

(57) ABSTRACT

Jigs and fixtures for aligning, guiding, and/or holding a workpiece on woodworking machinery during a woodworking operation are described, as well as methods of making, modifying, and using jigs and fixtures. A clamp-on flip stop assembly is coupleable to a pocket hole jig or a portable pocket hole jig and can function as a flip stop base and a support for other accessories. An adjustable U-shaped stop is securable to the top outside corner of the pocket hole drill guide and can be designed to fit on either side of the drill guide body. A horizontal adjustment screw positions the workpiece boards accurately and consistently for drilling. Two parallel tapered grooves on the outside of the threaded flanges of the U-shaped extrusion can be included to allow accessories to be secured to the jig.

### CROSS-REFERENCE TO RELATED APPLICATIONS

This application claims the benefit of U.S. Provisional Patent Application No. 62/702,705 filed Jul. 24, 2018, the disclosure of which is hereby incorporated by reference for all purposes.

### STATEMENT CONCERNING FEDERALLY SPONSORED RESEARCH OR DEVELOPMENT

Not applicable.

### FIELD OF THE INVENTION

This invention relates to jigs and fixtures for aligning, guiding, and/or holding a workpiece on woodworking machinery during a woodworking operation.

### BACKGROUND OF THE INVENTION

Woodworking machines utilize various means of positioning or securing a workpiece as it is cut, drilled, or routed. As standard equipment, a pocket hole jig is not fitted with a stop system for measuring the board location or for securing the workpiece in the desired location. A position stop enables a repeatable locating of the workpiece boards in relationship to the drill bit or cutter. A flip stop, which is rotated out of the way when not in use, also establishes a consistent workpiece location. The benefit of this technique is that the operator knows that the edge of the board being drilled is accurately positioned. The accuracy of processing multiple pieces is improved with a stop system. The position stops described in connection with one embodiment are configured to clamp onto a typical or standard pocket hole jig drill guide without the need for additional drilling or fabrication.

### SUMMARY OF THE INVENTION

Jigs and fixtures for aligning and positioning a workpiece on woodworking machinery during a woodworking operation are described as well as methods for modifying and using jigs, fixtures, and position stops. For example, a clamp on flip stop for pocket hole jigs is described. A clamp on adjustable stop is fitted to the pocket hole drill guide for use on, for instance, a stationary or a portable pocket hole jig. A clamp on U-shaped fixture is secured to the top of a stationary pocket hole jig drill guide with a thumbscrew. A rotatable flip stop arm is secured to the end of the U-shaped fixture base with a thumbscrew. On the opposite end of the flip stop arm is a slot that accepts an adjustable bolt which contacts and accurately positions the workpiece. Two angled grooves are located on each side of the threaded hole in the U-shaped fixture. An L-shaped angled fixture is designed to be attached to the end of the U-shaped fixture. The L-shaped fixture has the short leg formed with two angled ribs that fit into the two angled grooves on each side of the U-shaped fixture threaded hole.

The long leg of the L-shaped fixture is a 45-degree angle designed to locate and support a 45-degree mitered workpiece. A 15 degree angled long leg is designed to locate and support a mitered workpiece at a 15-degree angle. A slot in the short leg of the L-shaped angled fixture allows it to be moved up and down and be secured to the U-shaped fixture with a threaded thumb screw.

A rectangular flip arm has a hole on one end and a slot on the opposite end. The hole fits on the threaded bolt shaft and is locked into the desired position with a thumbnut threaded into the hole on the end of the U-shaped fixture. A slot on the opposite end of the flip arm accepts an adjustable bolt, nut, and locking thumbnut which can be adjusted to position the location of the workpiece in relationship to the drill bit. A drill guide bushing fits in the typical or standard drill guide hole and allows smaller pocket hole drills to be used with the standard drill guide.

The foregoing and other objects and advantages of the invention will appear in the detailed description that follows. In the description, reference is made to the accompanying drawings that illustrate the preferred embodiments of the invention.

### BRIEF DESCRIPTION OF THE DRAWINGS

FIG. 1A is a perspective view of a KREG K4 pocket hole jig with an articulating flip stop assembly tightened to the end of the U-shaped fixture with a thumbnut which is located on the side of the jig. A rectangular workpiece board is clamped in the jig and is in contact with an adjustable positioning bolt secured in the flip stop assembly arm located on the side of the pocket hole jig.

FIG. 1B an enlarged view of the U-shaped clip-on fixture separated from the KREG K4 jig shown in FIG. 1A. Two mechanisms, for instance, can be used to secure the U-shaped clip-on fixture to the KREG K4 jig. Two semicircular tabs are located on the inside middle section of the U-shape. These tabs fit into the back of the jig body semicircular slots. Two rectangular tabs protrude from the inside corner of the U-shaped fixture and fit into the rabbets on the corners of the drill guide.

FIG. 1C is a perspective view of a KREG K4 jig viewed from the drill hole side of the pocket hole jig. The illustration shows the jig, the U-shaped clip-on fixture, and the articulating flip stop assembly.

FIG. 1D is a perspective view of a KREG K4 jig shown in FIG. 1C with the U-shaped fixture removed from the jig.

FIG. 2A is an exploded view of a KREG K4 jig, the U-shaped fixture, the articulating flip stop assembly arm with the mating hardware, and the adjustable positioning bolt.

FIG. 2B is an enlarged view of FIG. 2A illustrating the U-shaped clip-on fixture and the top of the KREG K4 jig with a dotted line showing how the semicircular tab on the fixture lines up with the semicircular slot in the jig.

FIG. 2C is an enlarged view of FIG. 2A illustrating the rabbet in the corner of the drill guide in alignment with the locking tab of the clip-on fixture.

FIG. 3A is a perspective view of a KREG K4 pocket hole jig shown from the clamp side with an articulating flip stop assembly tightened to the end of the U-shaped fixture with a thumbnut which is located on the side of the jig. A rectangular workpiece board is clamped in the jig and is in contact with an adjustable positioning bolt secured in the flip stop assembly arm located on the side of the pocket hole jig.

FIG. 3B is an exploded view of the KREG K4 jig, the drill guide, and the flip stop arm assembly. The U-shaped fixture is located on the top of the KREG K4 jig. The drill guide is positioned above the drill guide cavity. When the drill guide is placed in the drill guide cavity, it inhibits the U-shaped fixture from moving.

FIG. 3C is an enlarged view of FIG. 3B illustrating the semicircular tab of the U-shaped fixture fitting into the semicircular opening in the KREG K4 jig.

FIG. 3D is an enlarged view of the drill guide.

FIG. 3E is an enlarged view of the corner of the drill guide in FIG. 3D illustrating the rabbet in the corner of the drill guide for alignment with the locking tab of the clip-on fixture.

FIG. 4A is a perspective view of a KREG K4 pocket hole jig with a U-shaped fixture secured to the top of the drill guide with a thumbscrew on the drill guide side securing it to the drill guide. An articulating flip stop assembly is secured to the jig with a thumbnut which is located on the side of the fixture. A rectangular workpiece board is clamped in the jig and is in contact with an adjustable positioning bolt secured in the flip stop assembly arm. The bolt tightening the flip stop arm to the jig is fitted into a threaded hole.

FIG. 4B is an enlarged view of FIG. 4A illustrating the flip stop assembly.

FIG. 5A is a perspective exploded view of the pocket hole jig base without the drill guide.

FIG. 5B is a perspective exploded view of the U-shaped fixture with the adjustable flip stop bolt. The U-shaped fixture is roughly the same size as the cavity for the drill guide.

FIG. 5C is a perspective exploded view the drill guide.

FIG. 6A is a perspective view of a KREG K4 pocket hole jig with an articulating flip stop assembly tightened to the end of the U-shaped fixture with a thumbnut which is located on the side of the jig. A rectangular workpiece board is clamped in the jig and is in contact with an adjustable positioning bolt secured in the flip stop assembly arm.

FIG. 6B is a perspective view of the U-shaped fixture illustrating the threaded holes on each end and the two angled grooves on each side of the threaded hole. A threaded hole in the middle of the U-shaped fixture is for the tightening thumbscrew.

FIG. 6C is an exploded view of the U-shaped fixture and the adjustable flip stop bolt.

FIG. 7A is a perspective view of a portable base pocket hole jig with an articulating flip stop assembly tightened to the end of the U-shaped fixture with a thumbnut which is located on the side of the jig. A rectangular workpiece board is clamped in the jig and is in contact with an adjustable positioning bolt secured in the flip stop assembly arm.

FIG. 7B is an enlarged view of the adjustable positioning bolt secured in the flip stop assembly arm as shown in FIG. 7A.

FIG. 8A is a perspective exploded view of the pocket hole jig base without the drill guide.

FIG. 8B is a perspective exploded view of the U-shaped fixture with the adjustable flip stop bolt.

FIG. 8C is a perspective exploded view of the drill guide.

FIG. 9A is a perspective view of a portable base pocket hole jig with an articulating flip stop assembly tightened to the end of the U-shaped fixture with a thumbnut which is located on the side of the jig. A rectangular workpiece board is clamped in the jig and is in contact with an adjustable positioning bolt secured in the flip stop assembly arm.

FIG. 9B is an exploded view of the U-shaped fixture with the adjustable flip stop bolt.

FIG. 9C is a perspective view the U-shaped fixture.

FIG. 10A is an exploded view of the U-shaped fixture with an extension spacer located on each end of the fixture. There is a single tightening thumbscrew in the middle of the back of the U-shaped fixture. An extension spacer is shown on each end of the U-shaped track extension which has two angled ridges that fit into the angled grooves on each end of the U-shaped fixture.

FIG. 10B is an enlarged view of FIG. 10A showing the U-shaped fixture end and the extension spacer.

FIG. 10C is an enlarged view of the extension spacer.

FIG. 10D is a perspective view of a one-piece U-shaped fixture with the same inside shape as FIG. 10A and the outside circumference of the U-shaped fixture with the extension spacers added.

FIG. 10E is an enlarged view of FIG. 10D.

FIG. 10F is a perspective view of the KREG K4 stationary pocket hole jig fitted with the U-shaped fixture and stop assembly. The illustration shows that the distance between the outside of the hole guide and the inside of the flip stop can be 1 inch in one embodiment. A panel workpiece is illustrated in the drawing. The 1-inch distance is the preferred measurement from the edge of the pocket hole to the edge of the panel in certain applications.

FIG. 10G is a perspective view of a representation of the 1-inch distance measurement from the edge of the pocket hole to the edge of the panel in certain applications, as shown in FIG. 10F.

FIG. 11A is a perspective view of a KREG K4 pocket hole jig with an articulating flip stop assembly tightened to the end of the U-shaped fixture with a thumbnut which is located on the side of the jig. A rectangular workpiece board is clamped in the jig and is in contact with an adjustable positioning bolt secured to the flip stop arm with a thumbnut.

FIG. 11B is an enlarged view of the U-shaped fixture with the adjustable flip stop bolt assembly.

FIG. 11C is a plan view of an alternative flip stop shown in FIG. 11B. It has the straight end slot for mounting the adjustable measuring bolt, an end rotation point, and a modified slot opening with a side opening for easy removal and reattachment. The example illustration is shown with a ¼″ grid.

FIG. 11D is a plan view of the flip stop showing the end rotation point is sized to fit the example ¼″ diameter shaft of the securing thumbscrew. The flip stop middle rotation point is also sized to fit the ¼″ diameter shaft of the securing thumbscrew.

FIG. 11E is a plan view showing the end rotation point that allows the arm to be rotated into the engaged flip stop position or away from the engaged position.

FIG. 12A is a perspective view of the KREG K4 jig with a workpiece panel clamped to the jig. The flip stop arm is secured to the U-shaped extrusion and is hanging down vertically in the standby position.

FIG. 12B is an enlargement of FIG. 12A showing a magnet attached to the metal floor of the clamp. The flip stop adjustment bolt, nut, and thumbnut are shown secured to the magnet thus providing a handy storage location.

FIG. 12C is an enlarged plan view of the flip stop arm located in the end rotation hole in the standby position.

FIG. 12D is a plan view that shows the flip stop arm suspended on the thumbscrew shaft located in the outside hole. The solid line illustrates the engaged position and the dotted line illustrates the flip stop arm in the standby position.

FIG. 12E is a perspective view showing the flip stop arm hanging in the natural engaged position at which it extends partially into the workpiece plane.

FIG. 12F is a plan view that shows the flip stop arm suspended on the thumbscrew shaft located in the middle hole. The solid line illustrates the engaged position and the dotted line illustrates the flip stop arm in the standby position. The middle hole is located at a balance point in which the straight flip arm stop hangs down at approximately a 45-degree angle. When the flip stop arm is secured loosely with the thumbscrew it can rotate from the engaged position to the standby position by shoving the workpiece panel against it.

FIG. 13A shows a perspective drawing of the KREG portable base with the U-shaped fixture attached to the drill guide. A 45-degree miter fixture is attached to the side of the U-shaped fixture with a thumbscrew. The thumbscrew is positioned through a long slot in the short leg of the L-shaped 45-degree fixture and secures the angled fixture to the U-shaped clamp-on fixture. The outside edge of the mitered board rests against the bottom of the 45-degree miter fixture. Moving the 45-degree miter fixture up or down adjusts the position of the mitered workpiece in relationship to the pocket hole bushings.

FIG. 13B shows a perspective of the jig, fixture, and workpiece illustrated in FIG. 13A from the opposite view. The workpiece is represented with dotted lines. This illustration shows how the workpiece rests against the 45-degree angle of the fixture and that the drill holes are located in the middle of the mitered board.

FIG. 14A is a front view of the 45-degree angled fixture illustrating how the workpiece rests against the 45-degree angle of the miter fixture. The mitered workpiece is represented with dotted lines.

FIG. 14B is a plan view that illustrates the drill holes located in the middle of the mitered board.

FIG. 14C shows an exploded perspective of the example U-shaped fixture extrusion and the L-shaped 45-degree fixture. Between the U-shaped fixture and L-shaped fixtures is a small spacer that fits between the two fixtures. The spacer positions the L-shaped 45-degree angle fixture away from the tapered body of the pocket hole jig. The spacer has a set of grooves on one side and ribs on the opposite side so that it fits between the 45-degree L-shaped fixture and the U-shaped clamp on fixture. A hole in the middle of the spacer allows the tightening bolt to secure the parts together.

FIG. 14D is an enlarged exploded view of FIG. 14C showing details of the spacer.

FIG. 15A shows an exploded top perspective view of the U-shaped fixture extrusion and the L-shaped 45-degree fixture. Between the U-shaped and L-shaped fixtures is a small spacer that fits between the two fixtures. The spacer positions the L-shaped 45-degree angle fixture away from the tapered body of the pocket hole jig. The spacer has a set of tapered grooves on one side and tapered ridges on the opposite side so it fits between the 45-degree L-shaped fixture and the U-shaped clamp-on fixture. A hole in the middle of the spacer allows the tightening bolt to secure the parts together.

FIG. 15B is a detailed exploded view of the FIG. 15A.

FIG. 15C is a top perspective view of the spacer illustrated in the FIG. 15A showing the tapered grooves on one side and tapered ridges on the opposite side. These spacer grooves and ridges mate with the matching grooves and ridges of the 45-degree L-shaped fixture and the U-shaped clamp-on fixture.

FIG. 16A shows a perspective of the portable base jig with a mitered board clamped in the jig with an L-shaped 45-degree fixture touching the outside edge of the 45-degree mitered workpiece. The thumbscrew is positioned through a long slot in the short leg of the L-shaped 45-degree fixture and secures the angled fixture to the U-shaped fixture clamped onto the top of the drill guide.

FIG. 16B is a top view of FIG. 16A.

FIG. 16C is a detailed perspective view of FIG. 16B.

FIG. 17A is an exploded perspective view of the portable jig base, the pocket hole drill guide, the U-shaped fixture, the L-shaped fixture, and the spacer.

FIG. 17B is an enlarged view detail view of the spacer shown in FIG. 17A.

FIG. 18A is an exploded perspective view of the front of the portable jig base, the pocket hole drill guide, the U-shaped fixture, the L-shaped fixture, and the spacer.

FIG. 18B is an enlarged view of FIG. 18A illustrating the tapered grooves and ridges of the miter fixture, the spacer, and U-shaped fixture.

FIG. 19A is a perspective of the L-shaped 45-degree fixture.

FIG. 19B illustrates the top of the L-shaped 45-degree fixture.

FIG. 19C is an inside end view of the L-shaped 45-degree fixture.

FIG. 19D is a side end view of the L-shaped 45-degree fixture.

FIG. 19E is an outside end view of the L-shaped 45-degree fixture.

FIG. 20A is a perspective view that illustrates a woodworking joint with two mitered pieces cut at 45 degrees. One of the mitered joints has two pocket holes drilled at a 90-degree angle to the 45-degree mitered cut. Those pocket holes clamp the inside of the mitered joint together. The mating mitered piece has a pocket hole drilled at an angle of 15 degrees from the outside edge of the workpiece. A pocket hole screw angled at a 15-degree angle near the point of the miter pulls the tips of the miter joint together.

FIG. 20B shows a perspective view of the portable base jig with a mitered board clamped in the jig with an L-shaped 15-degree fixture touching the outside edge of the 45-degree mitered workpiece. The 15-degree fixture is similar to the 45-degree fixture illustrated in FIG. 13A except that the angle is changed to 15 degrees. The thumbscrew is threaded through a long slot in the short leg of the L-shaped 15-degree fixture and secures the angled fixture to the U-shaped fixture clamped onto the top of the drill guide. The slot allows the fixture to be moved up and down to adjust the workpiece in relationship to the pocket hole drill guides.

FIG. 20C shows a perspective of the jig, fixture, and workpiece.

FIG. 20D shows a simplified perspective of the jig, fixture, and workpiece. The workpiece is represented with dotted lines. This illustration shows how the workpiece rests against the 15-degree angle of the fixture and how the drill hole is located in the tip of the mitered board.

FIG. 21A is a perspective of the example KREG drill guide fitted with a drill bushing that fits in a drill guide hole. The bushing has an outside diameter of about 0.370″ to fit in the standard KREG jig drill guide 0.375″ hole. The inside diameter is about 0.305″ and is designed to allow the smaller 0.300″ KREG mini-drill to be used in the standard 0.375″ drill guide hole. A flange on top of the bushing locates and accurately positions the bushing. A tab rests against the drill guide and prevents it from rotating. An angled bushing end fits tightly against the workpiece to prevent chipping and tear out.

FIG. 21B is a perspective of the drill guide bushing and flange.

FIG. 21C is a front perspective view of a drill guide which fits into the KREG drill guide and is configured to allow the smaller 0.300″ mini-drill to be used in the standard 0.375″ drill guide hole.

FIG. 21D is an enlargement detailed view of FIG. 21C illustrating the smaller 0.300″ pocket hole bushing.

FIG. 22A shows a perspective view of the KREG portable base jig with a mitered board positioned in the jig with an L-shaped 15-degree fixture touching the outside edge of the 45-degree mitered workpiece and also supporting the miter tip of the workpiece 100. The thumbscrew is threaded through a long slot in the short leg of the L-shaped 15-degree fixture and secures the angled fixture to the U-shaped fixture clamped onto the top of the drill guide. The miter is similar to the 15-degree angle fixture shown in FIG. 20C but the configuration is modified by extending its length and forming a 45-degree opening that supports the tip of the miter from both sides. The design is reversible so it can easily be switched from one side of the drill guide to the other. The 15-degree fixture is movable up and down for adjusting the position of the mitered workpiece in relationship to the pocket hole bushings.

FIG. 22B is an exploded perspective view of the front of the KREG portable jig base, the KREG pocket hole drill guide, the U-shaped fixture, and the L-shaped 15-degree fixture.

FIG. 22C shows a perspective view of the KREG portable base jig with a mitered board positioned in the jig with an L-shaped 15-degree fixture touching the outside edge of the 45-degree mitered workpiece and also supporting the miter tip of the workpiece. The mitered workspace is shown with dotted lines.

FIG. 22D is an enlarged detail view of FIG. 22C.

FIG. 23A is a perspective of the L-shaped 15-degree fixture with a 45-degree opening for supporting both sides of a 45-degree mitered board.

FIG. 23B illustrates a top view of the L-shaped 15-degree fixture.

FIG. 23C is an outside end view of the L-shaped 15-degree fixture.

FIG. 23D is a side end view of the L-shaped 15-degree fixture.

FIG. 23E is an inside end view of the L-shaped 15-degree fixture.

### DETAILED DESCRIPTION OF THE PREFERRED EMBODIMENT

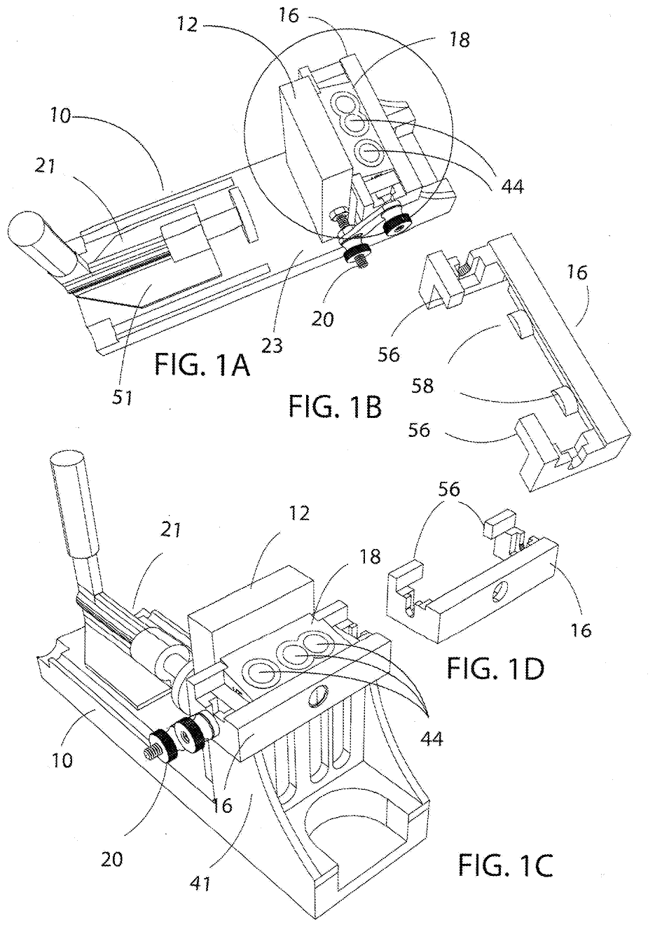

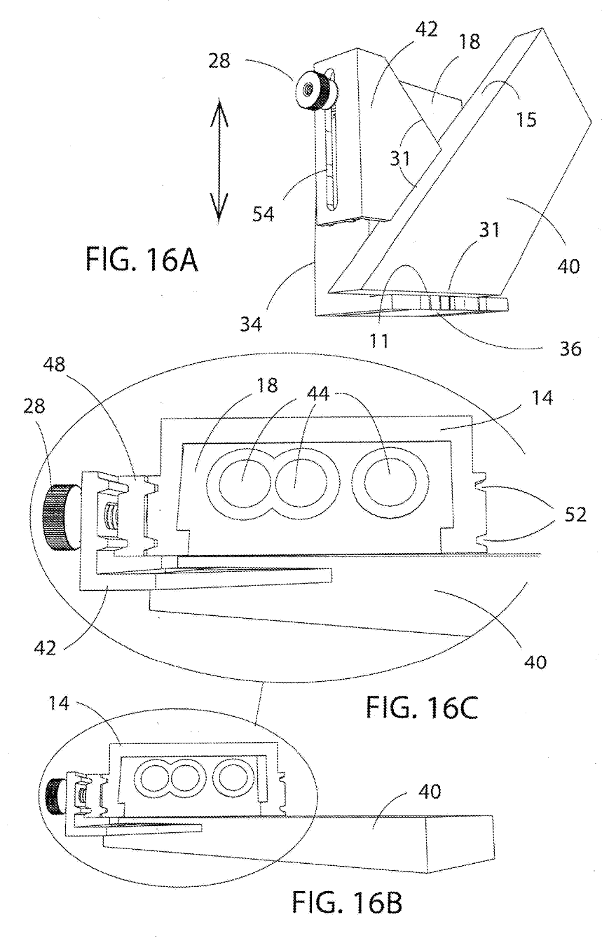

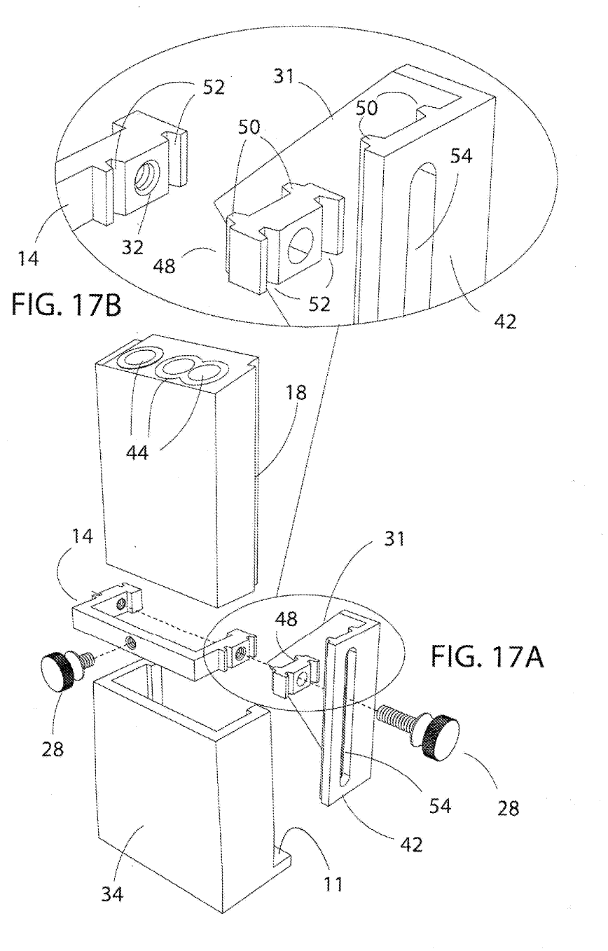

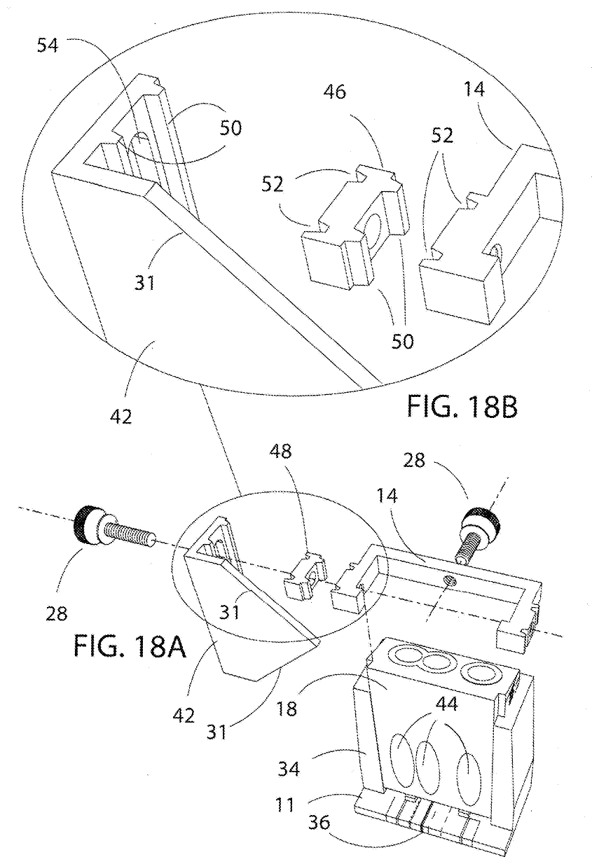

Embodiments of the invention are illustrated in extensive detail in the accompanying FIGS. 1-23, and as set forth above in the description of the accompanying FIGS. 1-23. As shown in the FIGS. 1-23, jigs and fixtures for aligning, guiding, and/or holding a workpiece on woodworking machinery during a woodworking operation are described, as well as methods of making, modifying, and using jigs and fixtures.

A clamp-on U-shaped fixture with a flip stop assembly featuring a locking bolt is secured to the top of the drill guide of a stationary pocket hole jig or the portable base is disclosed. It can function as a flip stop base and support a flip stop arm. It is configured to be reversible and fit on either side of the drill guide body. It can function as a position stop when the KREG drill guide is used with the stationary base of the example KREG K3, K4, and K5 or the portable base. A horizontal adjustment bolt positions the workpiece boards accurately and consistently for drilling. A modified flip stop arm has an outer rotation point which allows it to be flipped out of the way and a middle rotation point which allows it to function as a swing stop and be moved out of the way when the workpiece urges it so. In addition, the short leg of an L-shaped extrusion can be secured to the side of the U-shaped fixture replacing the flip stop arm. The long leg of the L-shaped extrusion may be cut at a 15 or 45-degree angle to support a mitered work piece during the drilling operation is also disclosed.

Also disclosed is a drill guide sleeve that is fitted inside the pocket hole jig drill guide hole used for accurately drilling smaller pocket holes with the standard drill guide block. Preferred embodiments of the invention have been described in considerable detail. Given the benefit of this disclosure, modifications and variations to the preferred embodiment described will be apparent to a person of ordinary skill in the art. Therefore, the invention should not be limited to the embodiments described.

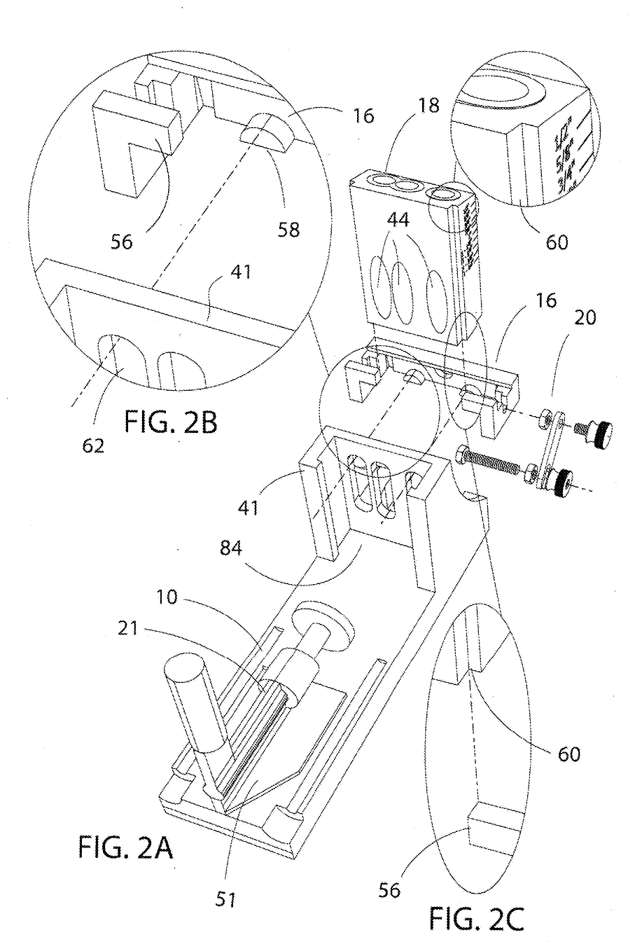

Referring to FIG. 1A a woodworking machinery jig and fixture is disclosed incorporating an example KREG pocket hole jig 10 having a drill guide 18 and a clamp-on U-shaped fixture 16 which supports a flip stop assembly 20. In other forms, the fixture 16 can be engaged and coupled in other ways, such as slid on or over the drill guide 18, for instance. As shown in FIG. 1B the U-shaped fixture 16 is held in place by a semicircular tab 58 and a rectangular tab 56. Referring to FIG. 1C the pocket hole guide bushings 44 are located in the drill guide 18 adjacent to the workpiece 12. A rectangular workpiece board 12 is positioned on the jig 10 and is in contact with an adjustable positioning bolt secured in the flip stop assembly arm 20 located on the side of the clamp-on U-shaped clip on fixture 16. As shown in FIG. 1B the fixture 16 can be held in place by a semicircular tab 58 and rectangular tab 56. The semicircular tabs 58 fit into the back of the jig body semicircular slots 62 (shown in FIG. 2B).

FIG. 1B and FIG. 1D illustrate the outside and inside shape of the example injection molded shape of the U-shaped fixture 16. The fixture 16 can be manufactured using a variety of techniques, such as milled, extruded, cast, and the like.

FIG. 2A is an exploded view of the example KREG K4 jig body 10, the KREG drill guide 18, and a clamp-on U-shaped fixture 16 which supports the flip stop assembly 20. FIG. 2B is an exploded view of the injection molded U-shaped fixture 16 and the KREG stationary jig 10 illustrating the semicircular tabs 58 which protrude from the inside corner of the U-shaped fixture 16 and fit into the semicircular top of an elongated slot 62 of the KREG jig 10. FIG. 2C illustrates that the rectangular tabs 56 protrude from the inside corner of the U-shaped fixture 16 and fit into the rabbets 60 on the corners of the drill guide 60. These mating features can be adapted to correspond with, for instance, alternative structures of the drill guide and drill guides of varying form factors.

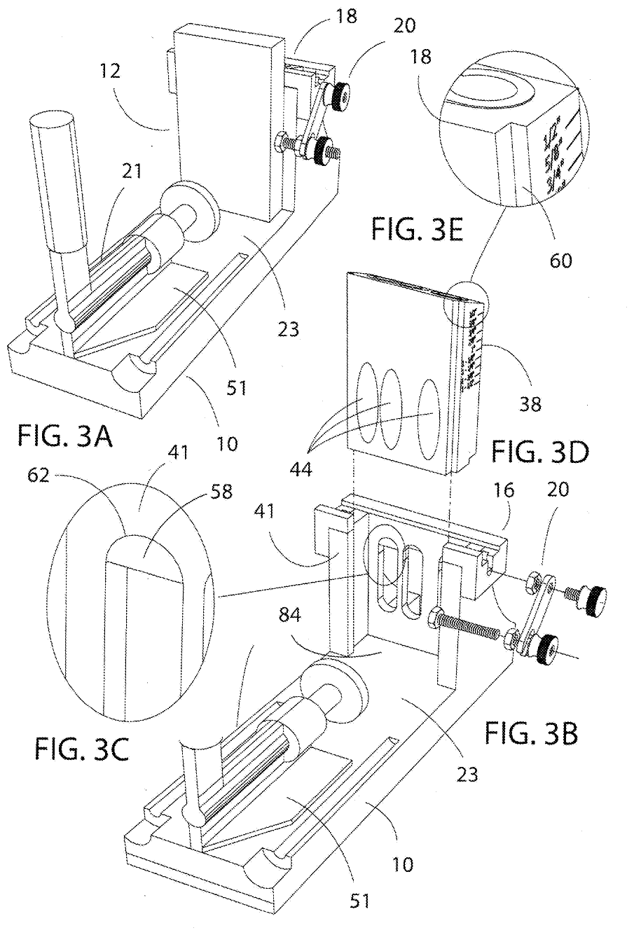

FIG. 3A is a perspective view shown from the clamp side of the jig with an articulating flip stop assembly 20 positioned on the side of the jig 10. The flip stop arm assembly 20 is attached to the U-shaped fixture and the contacts workpiece 12. FIG. 3B is a perspective exploded view of the KREG stationary jig 10 and the drill guide 18. The drill guide 18 is positioned above the drill guide cavity 84 in the KREG K4 pocket hole jig 10. The injection molded U-shaped fixture 16 is positioned on top of the KREG stationary jig 10. When the drill guide 18 is positioned in the drill guide cavity 84 it inhibits the U-shaped fixture 16 from moving. FIG. 3C is an enlarged view of the semicircular tab 58 which protrudes from the inside corner of the U-shaped fixture 16 and fits into the semicircular top of an elongated slot 62 of the KREG jig 10.

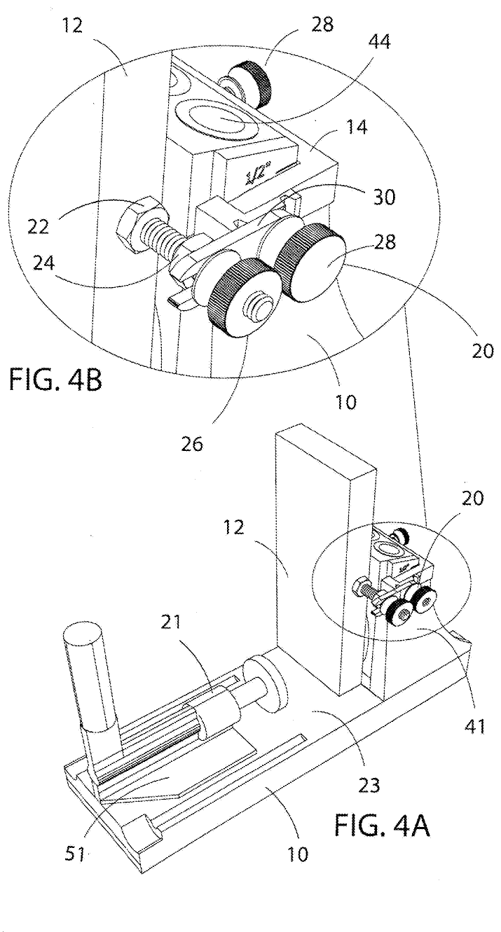

FIG. 4A is a perspective view of a KREG K4 pocket hole jig 10 shown from the clamp side of the jig with an articulating flip stop assembly 20 positioned on the sides of the jig 10. FIG. 4B is an enlarged view of FIG. 4A illustrating the flip stop assembly 20 with a U-shaped aluminum extrusion fixture 14 secured to the drill guide 18 with a thumbscrew 28. A rectangular workpiece board 12 is positioned on the jig and is in contact with an adjustable positioning bolt 22 secured in the flip stop arm 30 with a nut 24 and a thumbnut 26. As noted, the U-shaped fixture can be manufactured via a variety of techniques; additionally, while the body of the U-shaped fixture is illustrated as a generally continuous component, it can alternatively be constructed of multiple components permanently or releasably secured.

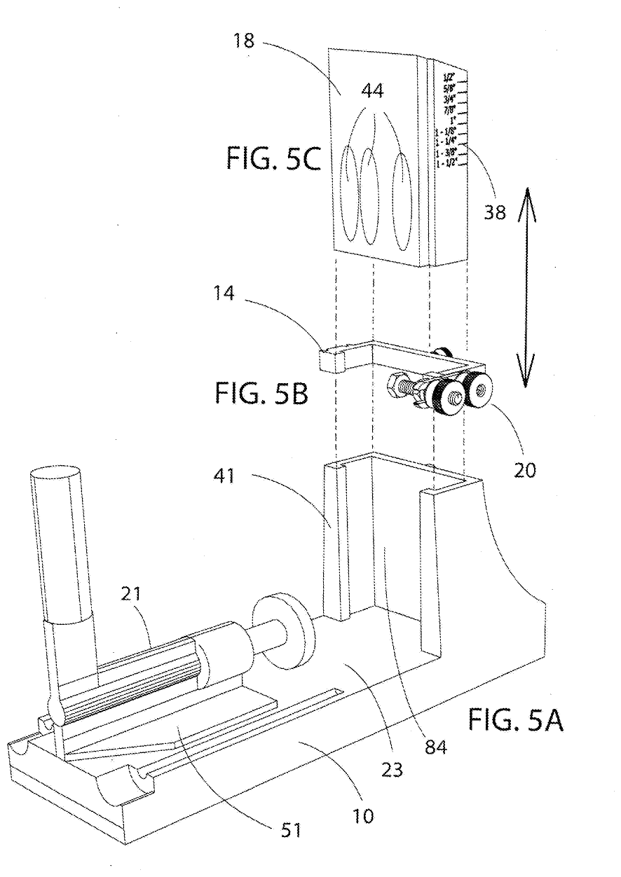

FIG. 5A is a perspective exploded view of the pocket hole jig without the drill guide 10 illustrating the drill guide cavity 84. FIG. 5B is a view of the U-shaped aluminum extrusion fixture 14 with the adjustable flip stop bolt assembly 20. FIG. 5C is a view of the drill guide 18 illustrating the drill bushing holes 44 and the height scale 38. In one embodiment, the inside shape of the U-shaped aluminum extrusion fixture 14 is about the same size as the drill guide cavity 84 in the stationary KREG jig K4 body 10. The drill guide cavity 84 is the same size as the stationery KREG K3, K4, K5 and the portable base 34, which means that the example U-shaped aluminum extrusion fixture 14 is generally compatible with all four of the KREG tools which employ the KREG drill guide 18.

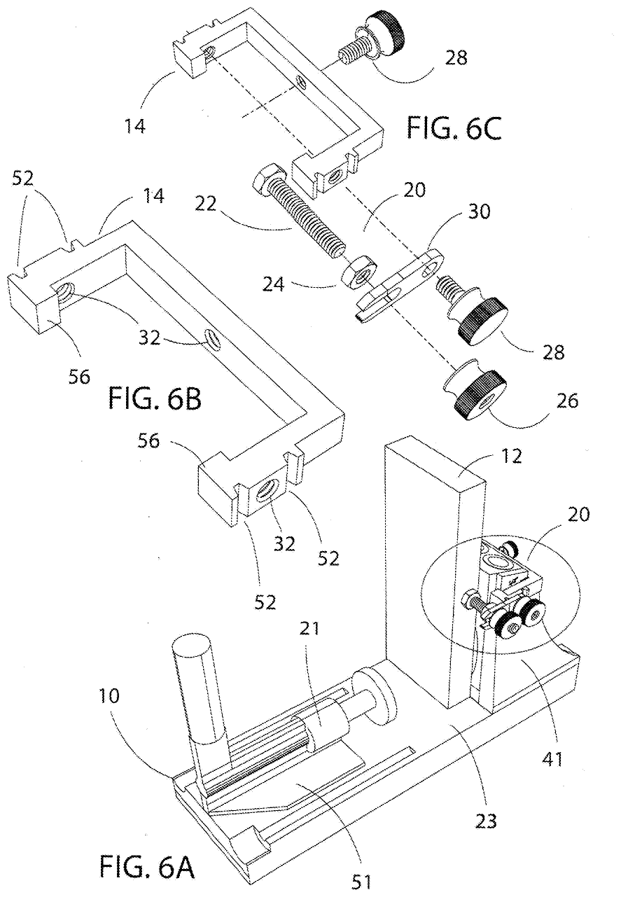

FIG. 6A is a perspective view of a KREG K4 pocket hole jig 10 with an articulating flip stop assembly 20 tightened to the end of the U-shaped fixture 14 with a thumbnut 28 which is located on the side of the jig. A rectangular workpiece board 12 is positioned on the jig 10 and is in contact with an adjustable positioning bolt secured in the flip stop assembly arm 20. FIG. 6B is an exploded view of the U-shaped aluminum extrusion fixture 14 illustrating the threaded holes 32 on each end and in the middle of the long piece connecting the two ends. On each end of the U-shaped aluminum extrusion fixture 14 are the two angled grooves 52 on each side of the threaded hole 32. A threaded hole 32 in the middle of the U-shaped fixture 14 is designed to tighten it to the drill guide. The two angled grooves 52 on each side of the threaded hole 32 function as a connecting point for other fixtures. In some forms, the U-shaped aluminum extruded fixture 14 may be more economical to manufacture as compared to the injection molded plastic U-shaped fixture 16. FIG. 6C is an exploded view of the U-shaped aluminum extrusion fixture 14 and the adjustable flip stop bolt assembly 20 which includes the adjustable bolt 22, the flip stop arm 30, a nut 24, and a thumbnut 26. The extension of the adjustable bolt 22 from the flip stop arm 30 can be adjusted via placement of the nut 24 along the bolt 22 and engagement with the stop arm 30. The thumbscrew 28 attaches the flip stop arm 30 to the U-shaped aluminum extrusion fixture 14.

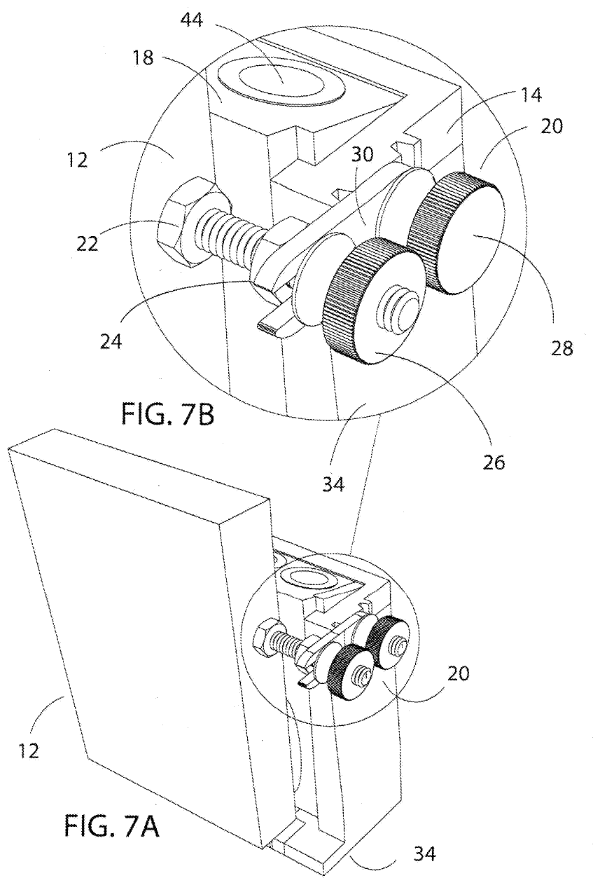

FIG. 7A is a perspective view of a KREG jig portable base 34 with an articulating flip stop assembly 20. FIG. 7B is an enlarged view of the flip stop assembly arm 20 as shown in FIG. 7A. FIG. 6C is an exploded view of the flip stop assembly arm 20.

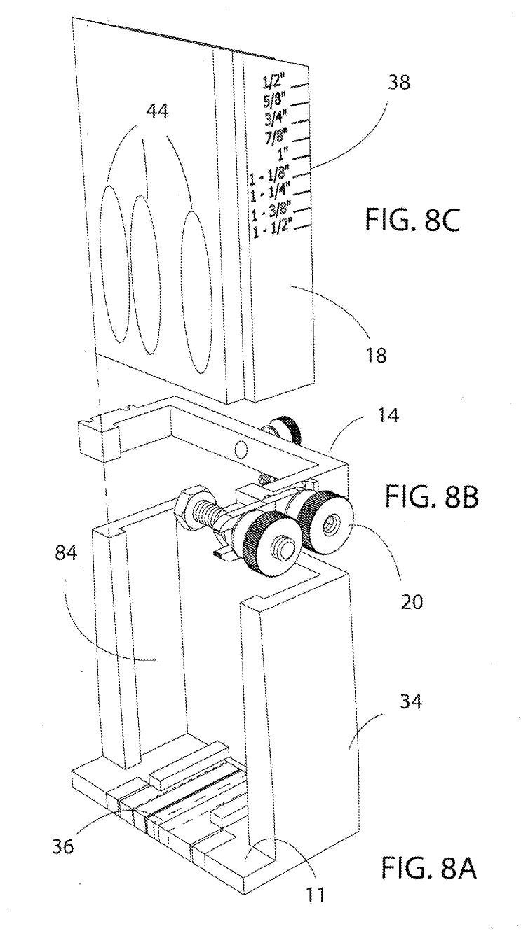

FIG. 8A is an exploded view of the pocket hole jig base 34 without the drill guide. FIG. 8B is an exploded view of the U-shaped fixture 14 with the adjustable flip stop assembly 20. FIG. 8C is an exploded view of the example drill guide 18.

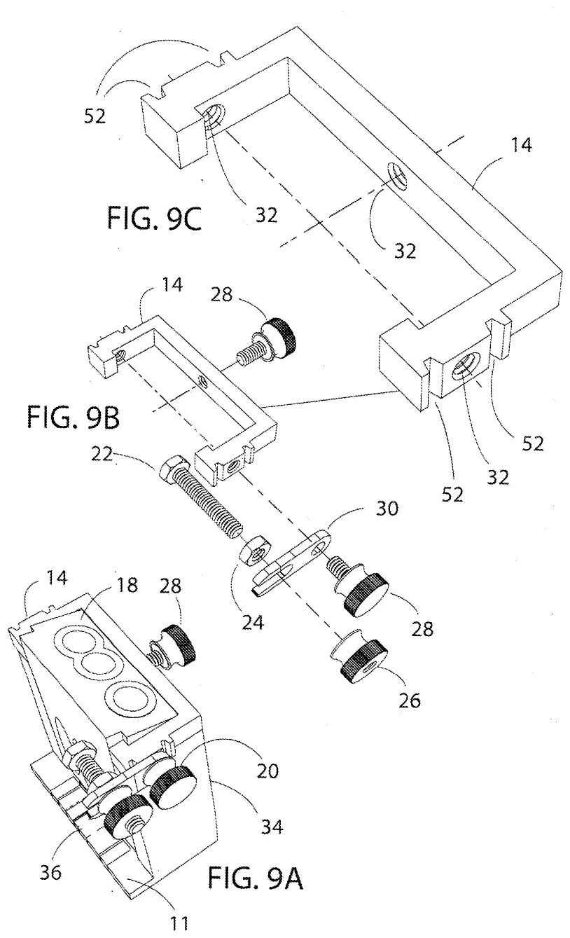

FIG. 9A is a perspective view of a KREG portable base 34 fitted with the KREG drill guide 18. Also illustrated is the U-shaped fixture 14 with the adjustable flip stop assembly 20. FIG. 9B is a view of the example U-shaped fixture 14 with the adjustable flip stop bolt 22, nut 24, flip stop arm 30, thumbnut 26, and thumbscrew 28. FIG. 9C is an isometric view of the U-shaped fixture 14.

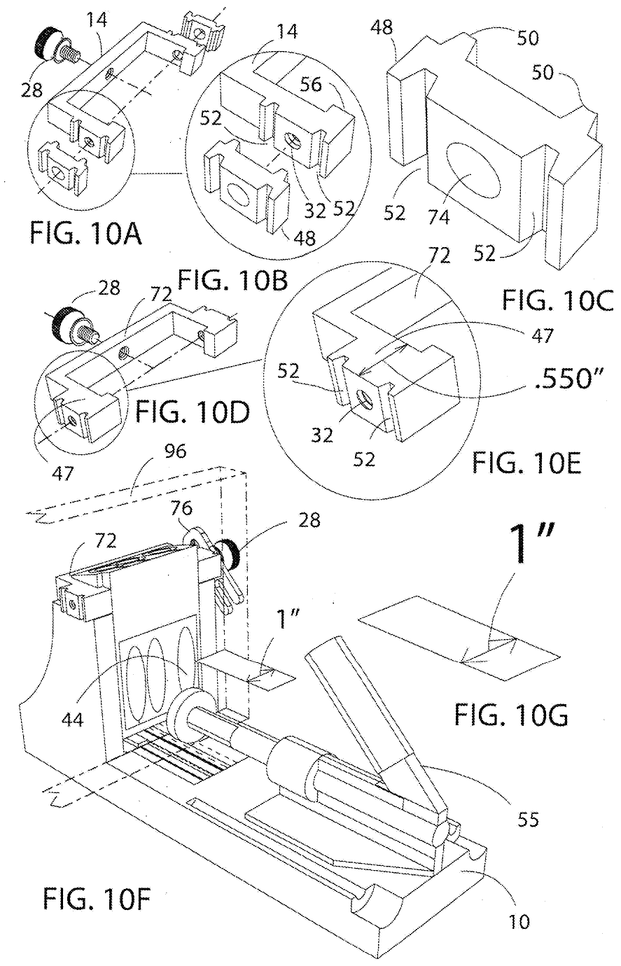

FIG. 10A is an exploded view of the U-shaped fixture 14 with an extension spacer 48 located on each end of the fixture. There is a single tightening thumbscrew 28 in the middle of the back of the U-shaped fixture 14. An extension spacer 48 is shown on each end of the U-shaped track extension 14; the extension spacer 48 shifts the placement of the example flip stop arm laterally away from the example pocket hole jig 10. FIG. 10B is an enlarged view of FIG. 10A showing the alignment and engagement between the U-shaped fixture 14 and the extension spacer 48. FIG. 10C is an enlarged view of the extension spacer 48. The extension spacer 48 has two angled ridges 50 that fit into the angled grooves 52 on each end of the U-shaped fixture 14. FIG. 10D is a perspective view of a one piece wide U-shaped fixture 72 which has the same inside shape as FIG. 10A and the outside dimension of the U-shaped fixture with the two extension spacers added. That is, the extension spacers 48 can be integral with the configuration of the U-shaped fixture 72. FIG. 10E is an enlarged end view of FIG. 10D illustrating the wide spacer end flange 47 which extends the flip stop arm away from the pocket hole jigs allowing more positioning options. The width of the example end flange 47 is about 0.550″. FIG. 10F is a perspective view of the one piece wide U-shaped fixture 72 located on the KREG K4 jig 10. The wide U-shaped fixture 72 has the advantage of allowing the manufacturing process to be simpler and cheaper by using one-piece construction. The wide U-shaped fixture 72 extends a flip stop 76 away from the pocket hole jig 10 and is designed to make the space between the inside of the flip stop 76 and the outside pocket hole of the drill guide bushing 44 about one inch. In certain applications and embodiments, a one-inch space is the preferred distance between the side of the pocket hole and the edge of the panel (e.g., FIG. 10G).

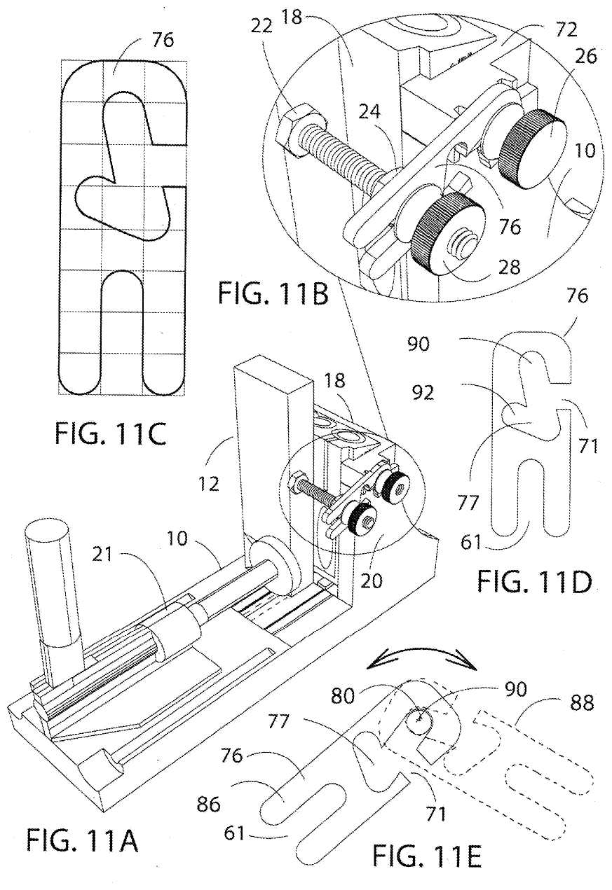

FIG. 11A is a perspective view of a KREG K4 pocket hole jig 10 with an articulating flip stop assembly 20, incorporating the modified flip stop arm 76. FIG. 11B is an enlarged view of the U-shaped fixture with the adjustable flip stop bolt assembly 20. FIG. 11C shows the example modified flip stop arm 76 laid atop a ¼″ grid to better illustrate the relative positioning of the features and contours of the flip stop arm 76 that allow, in one form, the desired functioning of the flip stop arm 76 as the flip stop arm 76 (and its center of mass) is urged by gravity, as further described below.

FIG. 11D illustrates that the flip stop arm 76 is a modification of the flip arm shown in other illustrations. The flip stop arm 76 has a straight end slot 61 for mounting the adjustable measuring bolt 22. And, the flip stop arm 76 defines an end rotation point 90, which allows the flip stop arm 76 to hang down (in a natural vertically in-line orientation) when in use and also has a contoured slot 77 with a side opening 71 for easy removal and reattachment. Inside the contoured slot 77 is a middle rotation point 92, which allows the stop arm 76 to hang at an angle (relative to vertical and the natural orientation taken by the flip stop arm 76 when hung from the end rotation point 90) and function as a swing stop. That is, the flip stop arm 76 is configured such that allowing the flip stop arm 76 to free hang (e.g., without any lateral clamping or other limiting force) from the end rotation point 90 or the middle rotation point 92 will result in the flip stop arm 76 settling in one of two discrete natural orientations depending upon which rotation point is in use. The geometry and form factor of the flip stop arm 76 establishes a generally vertical natural orientation of the flip stop arm 76 when the end rotation point 90 is used. Similarly, when the middle rotation point 92 is used, the geometry and form factor of the flip stop arm 76 established a generally skewed (e.g., off-vertical) orientation of the flip stop arm 76. While one example flip stop arm form factor is illustrated, given the benefit of this disclosure, one skilled in the art will appreciate the variety of form factors available to implement the desired discrete orientation properties of a modified flip stop, such as by modifying the relative positioning of the rotation points and center of mass/gravity. In one embodiment, the end rotation point 90 is sized to fit the ¼″ diameter shaft of the securing thumbscrew 80. The flip stop middle rotation point 92 is also sized to fit the ¼″ diameter shaft of the securing thumbscrew 80. Also, FIG. 11E illustrates that the end rotation point 90 allows the flip stop arm 76 to be rotated into the engaged position 86 or away from the engaged position 88, such as the flip stop arm 76 being rotated over the top center with the flip stop bolt 22 abutting the workpiece, and the flip stop arm 76 can be secured at any position along that path by the thumbscrew.

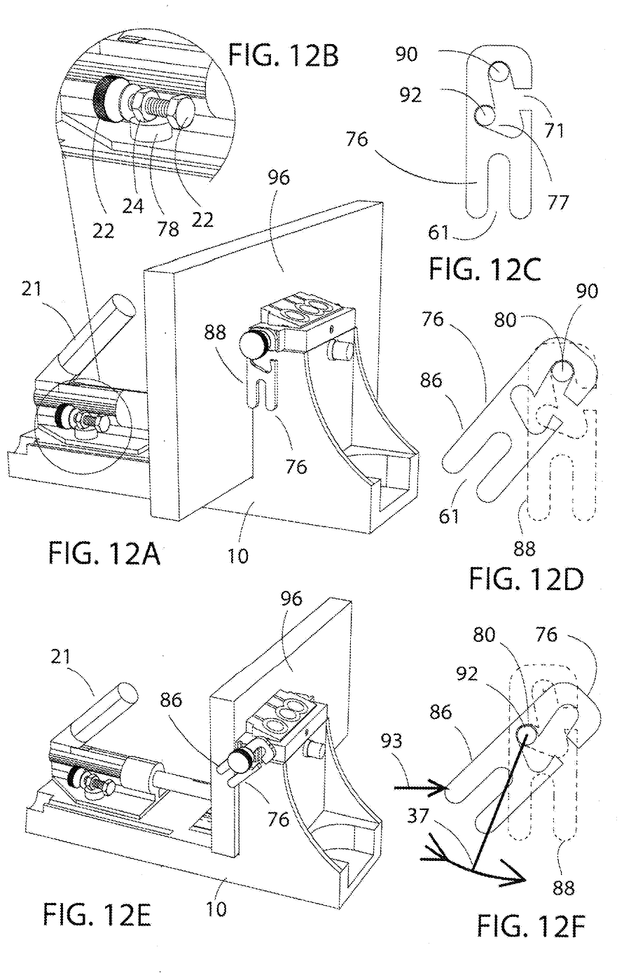

FIG. 12A is a perspective view of the KREG K4 jig 10 with a workpiece panel clamped to the jig 96. The example flip stop arm 76 is secured to the wide U-shaped aluminum extrusion 72 and hangs down vertically in the standby position 88. FIG. 12B is an enlargement of FIG. 12A showing a magnet 78 attached to the metal floor of the clamp 21. The flip stop assembly 20, which includes the adjustment bolt 22, nut 24, and thumbnut 26, is secured to a magnet 78 thus providing a handy storage location. FIG. 12C is an enlarged view of the flip stop arm 76 located in the end rotation hole 90 in the standby position 88. FIG. 12D illustrates the flip stop arm 76 suspended on the thumbscrew shaft 80 located in the outside rotation hole 90. The solid line illustrates the manipulated engaged position 86 and the dotted line illustrates the flip stop arm 76 in the natural stand by position 88. FIGS. 12E and 12F illustrate the flip stop arm 76 suspended on the thumbscrew shaft 80 located in the middle hole 92. The flip stop arm 76 is in the natural engaged position 86. The middle hole 92 of the example embodiment is located at a balance point at which the flip stop arm 76 hangs down at about 45-degree angle such that at least a portion of the flip stop arm 76 crosses a woodworking plane (e.g., generally the vertical plane at which the workpiece abuts the vertical face of the drill guide). When the flip arm 76 is secured loosely with the thumbscrew, it can be urged to rotate from the natural engaged position 86 to the manipulated standby position 88 by, for example, shoving/urging the workpiece panel against it. As force 93 is applied to the flip stop arm 76, the flip stop 76 rotates on the rotation point 92. The flip stop 76 goes through an arc 37 and transitions from the engaged position 86 to the standby position 88.

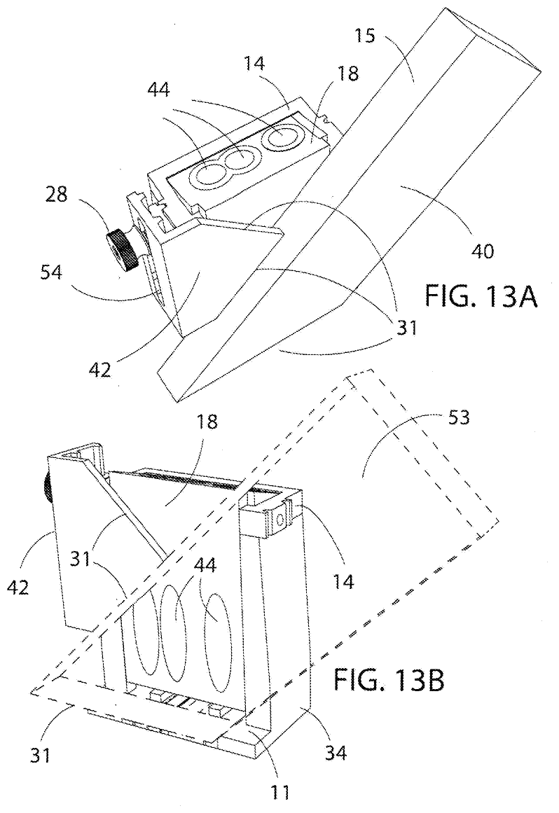

FIG. 13A shows a perspective drawing of the KREG portable base 34 with the U-shaped fixture 14 attached to the drill guide 18. A 45-degree miter fixture 42 is attached to the side of the U-shaped 14 fixture with a thumbscrew 28. The mitered workpiece 40 is positioned against the 45-degree miter fixture 42 and the floor 11 of the portable base 34. The mitered workpiece 40 shown with dotted lines 53 illustrates the location of the drill guide bushings 44 in relationship to the 45-degree miter fixture 42. The 45-degree miter fixture 42 can be moved up and down to adjust the position of the mitered workpiece 40 in relationship to the drill guides. FIG. 13B shows a perspective view of the KREG drill guide 18 with mitered workpiece 40 positioned against the 45-degree miter fixture 42 and the floor 11 of the portable base 34. A thumbscrew 28 is positioned through a long vertical slot 54 in the short leg of the L-shaped 45-degree fixture 42 and secures it to the U-shaped clamp-on fixture 14. An extension spacer 48 can be located between the U-shaped clamp-on fixture 14. The outside edge of the mitered board 40 rests against the bottom of the 45-degree miter fixture. Moving the 45-degree miter fixture up or down adjusts the position of the mitered workpiece in relationship to the pocket hole bushings 44.

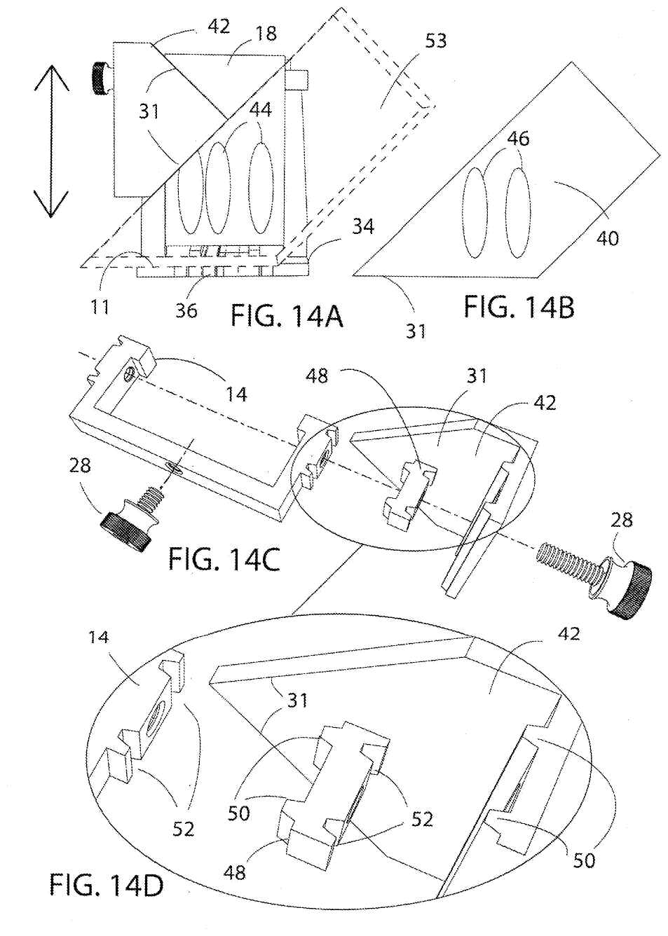

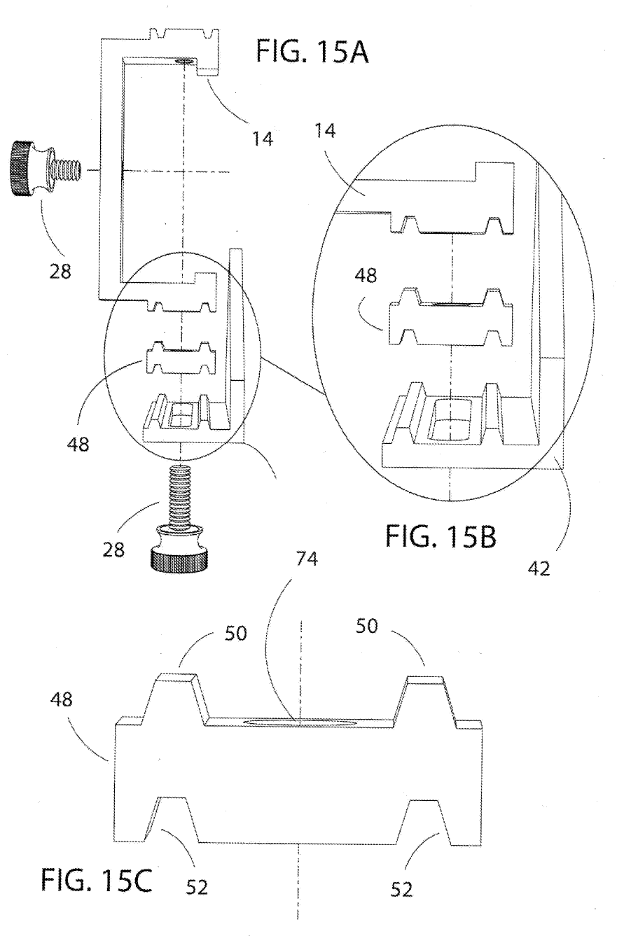

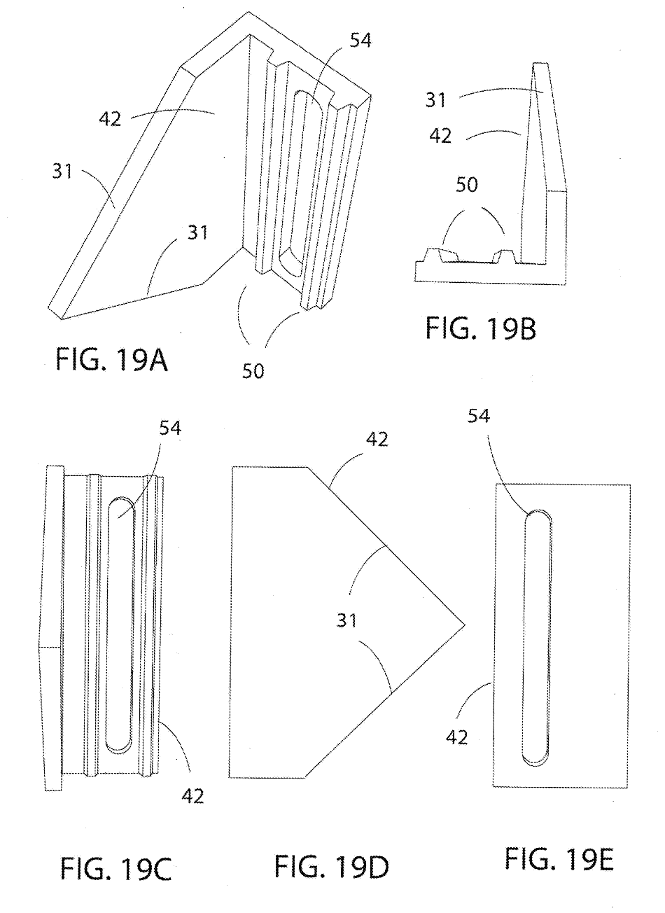

FIG. 14 A is a front view illustrating how the workpiece 53 rests against the 45-degree angle miter fixture 42 and the floor of the portable base 11. The mitered workpiece is represented with dotted lines 53. FIG. 14 B illustrates the pocket drill holes 46 located in the middle of the mitered board 40. FIG. 14C shows an exploded perspective of the U-shaped fixture extrusion 14, the extension spacer 48, and the L-shaped 45-degree fixture 42. Between the U-shaped fixture and L-shaped fixtures, in one embodiment, is a small extension spacer 48 that fits between the two fixtures. The extension spacer 48 positions the L-shaped 45-degree angle fixture 42 away from the tapered body of the KREG portable base 34. The spacer 48 has a set of grooves 52 on one side and ribs 50 on the opposite side so it fits between the 45-degree L-shaped fixture 42 and the U-shaped clamp-on fixture 14. A hole in the middle of the spacer allows the tightening bolt to secure the parts together. FIG. 14D is an exploded view of FIG. 14C showing details of the spacer 48. FIGS. 15-18 provide additional views of the features generally described in connection with FIGS. 13 and 14, including the miter fixture, the spacer, and U-shaped fixture. The L-shaped 45-degree fixture 42 is further shown in FIGS. 19A-E, whereat FIG. 19A is a perspective of the L-shaped 45-degree fixture 42, FIG. 19B illustrates the top of the L-shaped 45-degree fixture 42, FIG. 19C is an inside end view of the L-shaped 45-degree fixture 42, FIG. 19D is a side end view of the L-shaped 45-degree fixture 42, and FIG. 19E is an outside end view of the L-shaped 45-degree fixture 42.

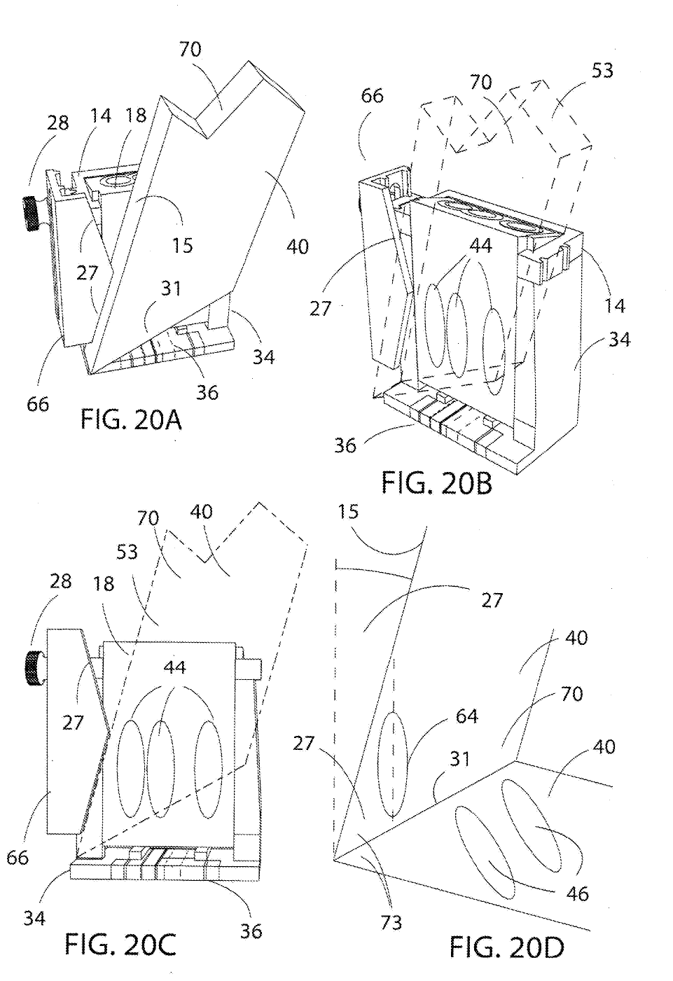

FIG. 20A shows a perspective of the jig 34, the 15-degree fixture 66 and mitered workpiece 40. The outside edge 15 of the mitered workpiece 70 rests against the 15-degree angle 27 and of the fixture 66. FIG. 20B shows a perspective of the jig 34, fixture 66, and workpiece 40. The workpiece is represented with dotted lines 53. This illustration shows how the workpiece rests against the 15-degree angle 27 of the fixture 66 and how the drill hole 64 is located in the tip of the mitered board 40. FIG. 20C shows a perspective of the portable base jig 34 with a mitered board 40 clamped in the jig with an L-shaped 15-degree fixture 66 touching the outside edge 15 of the 45-degree mitered workpiece 70. The 15-degree fixture 66 is similar to the 45-degree fixture 42 illustrated in FIG. 13A except that the angle is changed to 15 degrees. The thumbscrew 28 is threaded through a long slot in the short leg of the L-shaped 15-degree fixture 66 and secures the angled fixture to the U-shaped fixture 14 clamped onto the top of the drill guide 18. FIG. 20D illustrates a mitered joint 40, which has two mitered workpieces 70 cut at 45 degrees 31. One joint member has two pocket holes 46 drilled at a 90-degree angle to the mitered cut. Those pocket holes 46 clamp the inside of the mitered joint together. The mating mitered piece has a pocket hole 64 drilled at an angle of 15 degrees from the outside edge 15 of the workpiece. A pocket hole screw angled at a 15-degree angle near the point of the miter pulls the tips of the miter joint 73 together. The pocket hole 64 is located at a 15-degree angle 27 from the outside edge 15 of the mitered board 40.

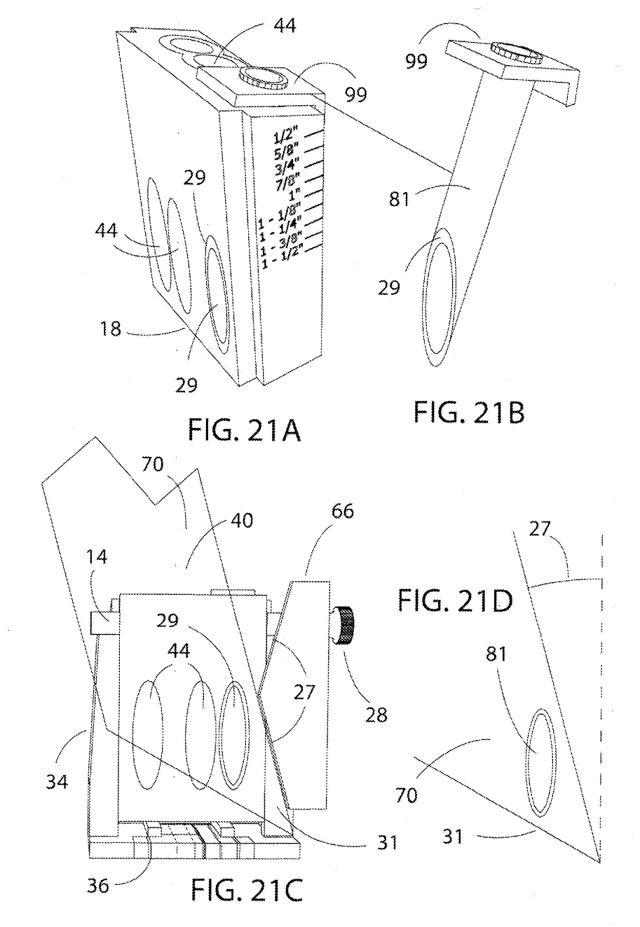

FIG. 21A is a perspective view of the KREG drill guide 18 fitted with a drill bushing 81 that fits in a drill guide hole 44. The bushing 81 has an outside diameter of about 0.370″ so that it fits in the standard KREG jig drill guide 0.375″ hole. The inside diameter is about 0.305″ and is configured to allow the smaller 0.300″ KREG mini-drill to be used in the standard 0.375″ drill guide hole. A flange 99 on top of the bushing 81 locates and accurately positions the bushing 81. An angled bushing end 29 fits tightly against the workpiece to prevent chipping and tear out. FIG. 21B is a perspective of the drill guide bushing 81 and the flange 99. FIG. 21C is a front perspective view of a drill guide bushing 81 which fits into the KREG drill guide 18 bushing hole 44 and FIG. 21D is an enlargement detailed view of FIG. 21C illustrating the smaller 0.300″ pocket hole bushing. The bushing 81 is configured to allow the smaller 0.300″ mini-drill to be used in the standard 0.375″ drill guide hole.

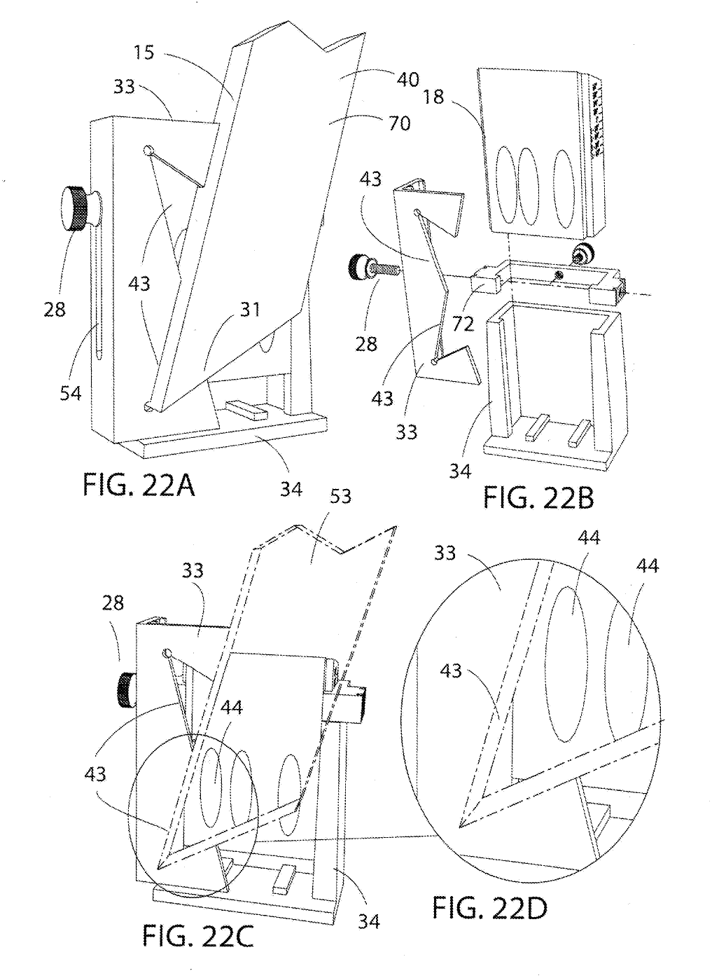

FIG. 22A shows a perspective view of the KREG portable base jig 34 with a mitered board 40 positioned in the jig with an L-shaped 15-degree fixture 33 touching the outside edge 15 of the 45-degree mitered workpiece, and also supporting the miter tip of the workpiece. The thumbscrew 28 is threaded through a long slot 54 in the short leg of the L-shaped 15-degree fixture 33 and secures the angled fixture 33 to the U-shaped fixture clamped 72 onto the top of the drill guide 18. The 15-degree miter jig 33 is similar to the 15-degree angle fixture 66 shown in FIG. 20C but the design is altered by extending its length and then forming a 45-degree opening 43 that supports the tip of the miter 31 from both sides. The design is reversible so it can easily be switched from one side of the drill guide to the other. The 15-degree fixture 33 is movable up and down for adjusting the position of the mitered workpiece in relationship to the pocket hole bushings. FIG. 22B is an exploded view of the front of the KREG portable jig base 34, the KREG pocket hole drill guide 18, the U-shaped fixture 72, and the L-shaped 15-degree fixture 33. FIG. 22C shows a perspective of the KREG portable base jig 34 with a mitered board 53 positioned in the jig with an L-shaped 15-degree fixture 33 touching the outside edge 15 of the 45-degree mitered workpiece 53 and also supporting the miter tip 31 of the workpiece. The mitered workspace is shown with dotted lines 53. FIG. 22D is an enlargement of FIG. 22C.

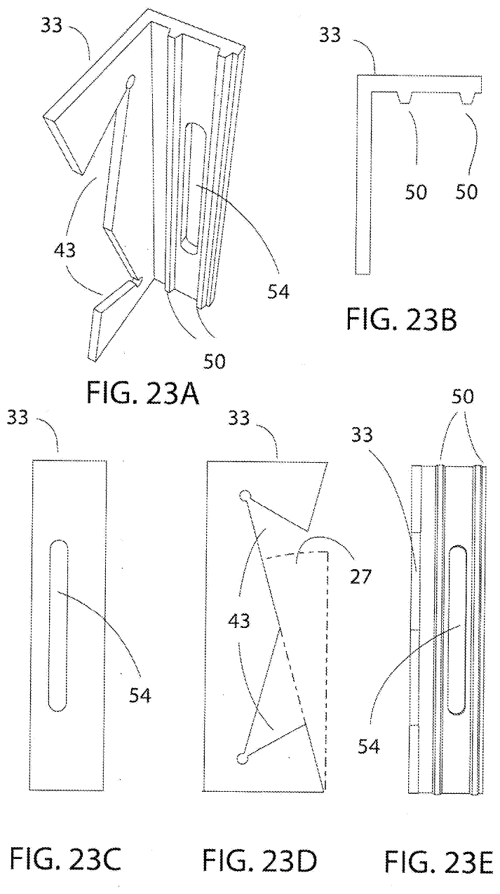

FIG. 23A is a perspective view of the example embodiment of the L-shaped 15-degree fixture 33 with a 45-degree opening 43 for supporting both sides of a 45-degree mitered board 40. FIG. 23B illustrates the top of the L-shaped 15-degree fixture 33. FIG. 23C is an outside end view of the L-shaped 15-degree fixture 33. FIG. 23D is a side end view of the L-shaped 15-degree fixture 33. FIG. 23E is an inside end view of the L-shaped 15-degree fixture 33. Given the benefit of this disclosure, one skilled in the art will appreciate the various modification to, for instance, the fixture 33, such as inclusion of only a single opening 43.

Preferred embodiments of the invention have been described in considerable detail. Many modifications and variations to the preferred embodiment described will be apparent to a person of ordinary skill in the art when given the benefit of this disclosure. Therefore, the invention should not be limited to the embodiment described.

1. A flip stop, the flip stop comprising:
a first rotation point at which the flip stop is configured to be hung for rotation about the first rotation point;
a second rotation point at which the flip stop is configured to be hung for rotation about the second rotation point;
wherein when the flip stop is hung from the first rotation point the flip stop defines a first natural orientation; and
wherein when the flip stop is hung from the second rotation point the flip stop defines a second natural orientation that is discrete from the first natural orientation.

2. The flip stop of claim 1, wherein:
the first natural orientation is generally in a vertical direction; and
the second natural orientation is skewed relative to the vertical direction.

3. A flip stop, the flip stop comprising:
a slot, the slot defining a first end, a second end, and an opening intersecting the first end and the second end;
wherein the first end defines a first axis of rotation and the second end defines a second axis of rotation; and
wherein the first axis of rotation and the second axis or rotation are offset it two mutually exclusive directions in a two-dimensional plane.

4. A flip stop for use with a woodworking device that defines a woodworking plane, the flip stop comprising:
a slot defining a first rotation point and a second rotation point separated by an opening;
wherein the flip stop is configured to be rotatably coupled to the woodworking device for rotation about the first rotation point or the second rotation point;
wherein when the flip stop is coupled to the woodworking device via the first rotation point, the flip stop is urged by gravity to assume a generally vertical orientation at which the flip stop does not intersect the woodworking plane; and
wherein when the flip stop is coupled to the woodworking device via the second rotation point, the flip stop is urged by gravity to assume a generally skewered orientation at which the flip stop intersects the woodworking plane.
